(19) United States
(12) Patent Application Publication
(10) Pub. No.: US 2025/0052375 A1
(43) Pub. Date: Feb. 13, 2025

(54) DEVICE, FACILITY AND METHOD FOR KEEPING A LIQUEFIED GAS STORE COLD

(71) Applicant: L'Air Liquide, Societe Anonyme pour l'Etude et l’Exploitation des Procedes Georges Claude, Paris (FR)

(72) Inventors: Remi NICOLAS, Sassenage (FR); Fabien DURAND, Sassenage (FR); Cecile GONDRAND, Sassenage (FR); Jean-Marc BERNHARDT, Sassenage (FR)

(73) Assignee: L'Air Liquide, Societe Anonyme pour l'Etude et l’Exploitation des Procedes Georges Claude, Paris (FR)

(21) Appl. No.: 18/796,792

(22) Filed: Aug. 7, 2024

(30) Foreign Application Priority Data
Aug. 8, 2023 (FR) FR 2308554

(51) Int. Cl. F17C 13/00

(52) U.S. Cl. CPC F17C 13/002; F17C 2205/0326; F17C 2205/0352; F17C 2221/033; F17C 2223/0153; F17C 2227/0135; F17C 2227/0157; F17C 2227/0353; F17C 2265/033; F17C 2270/0105

(57) ABSTRACT

A device and a method for keeping a liquefied gas store cold having a cryogenic refrigerator, a subcooling circuit having an aspiration end intended to be seated in a liquefied gas store, a heat exchanger exchanging heat between the aspirated subcooling circuit and the refrigerator, the subcooling circuit having at least one injection end configured to inject the fluid cooled in the heat exchanger into the store, the device further including a boil-off gas recovery pipe having an upstream end intended to be connected to the store to recover the boil-off gas, the recovery pipe comprising a downstream end intended to be connected to a consumer, the device having a bypass pipe and a set of valves configured to enable boil-off gas to be transferred from the recovery pipe to the subcooling circuit.

### CROSS-REFERENCE TO RELATED APPLICATIONS

This application claims the benefit of priority under 35 U.S.C. § 119 (a) and (b) to French patent application No. FR 2308554, filed Aug. 8, 2023, the entire contents of which are incorporated herein by reference.

### BACKGROUND

The invention relates to a device, a facility and a method for keeping a liquefied gas store cold.

### FIELD OF THE INVENTION

The invention relates specifically to a facility and a method for keeping a liquefied gas store, for example for liquefied natural gas, cold and/or pressurized.

### RELATED ART

The invention relates more specifically to a device for keeping a liquefied gas store cold, for example for liquefied natural gas, comprising a cryogenic refrigerator, a subcooling circuit comprising a set of pipes, the subcooling circuit comprising an aspiration end intended to be seated in a lower portion of a liquefied gas store and configured to aspirate the liquefied gas, a heat exchanger exchanging heat between the aspirated subcooling circuit and the refrigerator, the subcooling circuit comprising at least one injection end configured to inject the fluid cooled in the heat exchanger into the store, the device further comprising a boil-off gas recovery pipe having an upstream end intended to be connected to an upper portion of the store to recover the boil-off gas, the recovery pipe comprising a downstream end intended to be connected to a consumer of boil-off gas, for example a burner and/or a motor, the device comprising a bypass pipe and a set of valves configured to enable boil-off gas to be transferred from the recovery pipe to the subcooling circuit, the bypass pipe having a first end connected to the recovery pipe and a second end connected to the subcooling circuit.

The boil-off gas from a cryogenic fluid in a store can be recovered by direct re-liquefaction. The solution involves cryogenic compression of these boil-off gases, bringing them to ambient temperature, then sending them to a liquefactor.

Another function involves re-liquefying the boil-off gases by transferring cooling power from a refrigerator to the cryogenic liquid by subcooling it and returning it to the store. Document WO2019020742 A1 describes a facility for processing boil-off gas or cooling liquefied gas.

The cooling heat exchanger may become clogged by precipitation of the heaviest components (less solubility at lower temperatures). This is because the cryogenic fluid is not necessarily a pure component, and may be a mixture. This means that some components of the mixture may solidify during subcooling. These solid particles may clog the exchanger of the refrigerator, thereby degrading performance of the system.

There are different known solutions to reduce or limit such clogging. However, the solutions are unsatisfactory for both processing boil-off gases and/or subcooling a stored liquefied gas.

### SUMMARY OF THE INVENTION

One aim of the present invention is to overcome all or some of the aforementioned drawbacks of the prior art.

To this end, the device according to the invention, in other respects in accordance with the generic definition thereof given in the above preamble, is essentially characterized in that the second end of the bypass pipe is connected to the subcooling circuit upstream of the heat exchanger.

Furthermore, embodiments of the invention may include one or more of the following features:
the set of valves comprises a flow control valve on the bypass pipe,
the flow control valve is a controlled valve configured to transfer a boil-off gas flow to the subcooling circuit to increase the temperature of the fluid entering the heat exchanger by a given value, for example between 5° C. and 25° C.,
the flow control valve is a controlled valve configured to transfer a boil-off gas flow to the subcooling circuit to keep the temperature of the fluid entering the heat exchanger below the saturation temperature of the liquefied gas,
the flow control valve is a controlled valve configured to transfer a boil-off gas flow to the subcooling circuit to keep the temperature of the fluid coming out of the heat exchanger above a given value, for example above −160° C., and/or at a value equal to the temperature of the liquefied gas in the store, and/or at a value equal to the temperature of the liquefied gas aspirated at the aspiration end,
the recovery pipe comprises at least one compressor and the first end of the bypass pipe is connected to the recovery pipe downstream of the compressor,
the recovery pipe comprises several compressors in series, the first end of the bypass pipe is connected to the recovery pipe downstream of an intermediate compressor, i.e. upstream of the last compressor in the series,
the compressor is configured to supply a gas flow to the bypass pipe at a pressure greater than the pressure of the liquid aspirated at the aspiration end and supplied to the subcooling circuit,
the device includes a mixing unit for mixing the boil-off gas into the subcooling circuit, the mixing unit being located for example at the junction between the second end of the bypass pipe and the subcooling circuit, the mixing unit comprising at least one of the following: an indirect heat exchanger with injection, a gas injector into the liquid, a static mixer, an upstream injector, a filtration system, a condensate pot with random or structured packing,
the bypass pipe comprises a pre-cooling unit in thermal exchange with the boil-off gas being transferred to the subcooling circuit, the pre-cooling unit being configured for example to cool the transferred boil-off gas flow to an intermediate temperature between the temperature of the boil-off gas in the recovery pipe and the temperature of the liquefied gas,
the recovery pipe comprises a heat exchanger enabling a heat exchange between the boil-off gas in the recovery pipe and the boil-off gas in the bypass pipe,
the bypass pipe comprises a detour pipe and a set of valves to control the flow of boil-off gas in the bypass pipe admitted to flow through the heat exchanger on the recovery line,
the aspiration end comprises an aspiration pump.

The invention also relates to a liquefied gas storage facility, for example for liquefied natural gas, for example a boat carrying liquefied gas, comprising at least one liquefied gas store and a device for keeping the fluid contained in the store cold, the cold maintenance device having any one of the features set out above or below.

The invention also relates to a method for keeping a liquefied gas store cold using a device according to any one of the preceding claims, comprising pumping liquefied gas from a cryogenic store, cooling the pumped liquefied gas and re-injecting the cooled liquefied gas into the store, the method comprising recovering boil-off gas from the store, and a step of injecting and mixing boil-off gas into the pumped liquefied gas before it is cooled.

This makes it possible to increase the temperature of the fluid at the input of the subcooling circuit by injecting boil-off gas to prevent crystallization of heavy hydrocarbons in the heat exchanger 6, since the subcooler (refrigerator) is preferably configured to never bring the temperature of the fluid to be cooled below the initial temperature of the subcooled liquid.

According to other possible features, the injecting and mixing step is configured to raise the temperature of the pumped liquefied gas before cooling by a given value, and/or to keep the temperature of the cooled liquefied gas below a given threshold and/or at the temperature of the stored or pumped liquefied gas.

The invention may also relate to any alternative device or method comprising any combination of the features above or below within the scope of the claims.

Other particular features and advantages will become apparent from reading the following description, provided with reference to the figures, in which:

### BRIEF DESCRIPTION OF THE FIGURES

The invention will be understood better from reading the following description, which is given solely by way of example and with reference to the appended drawings, in which:

FIG. 1 is a schematic view illustrating an example of the structure and operation of a facility according to a first embodiment of the invention,

FIG. 2 is a schematic view illustrating an example of the structure and operation of a facility according to a second embodiment of the invention,

FIG. 3 is a schematic view illustrating an example of the structure and operation of a facility according to a third embodiment of the invention,

FIG. 4 is a schematic view illustrating an example of the structure and operation of a facility according to a fourth embodiment of the invention.

### DETAILED DESCRIPTION OF THE INVENTION

Throughout the figures, the same reference signs relate to the same elements. In this detailed description, the following embodiments are examples. Although the description refers to one or more embodiments, this does not mean that the features apply only to a single embodiment. Individual features of different embodiments can also be combined and/or interchanged to provide other embodiments.

The device 1 for keeping a liquefied gas store 2 cold, as illustrated, can for example be used to keep a liquefied natural gas tank, for example on a boat, cold and/or pressurized.

This device 1 comprises a cryogenic refrigerator 3 and a subcooling circuit 4, 5 comprising a set of pipes.

The subcooling circuit 4, 5 comprises at least one aspiration end 4 intended to be seated in a lower portion of a liquefied gas store 2 and configured to aspirate liquefied gas. As illustrated, the aspiration end 4 preferably comprises an aspiration pump 17.

The subcooling circuit 4, 5 further comprises a heat exchanger 6 exchanging heat between the aspirated subcooling circuit 4, 5 and the refrigerator 3. This heat exchanger 6 is preferably located outside the store 2.

The refrigerator may in particular comprise or be made up of a cryogenic liquefactor or refrigerator in which a cycle gas (helium, nitrogen, or any other pure gas or mixture) undergoes a thermodynamic cycle (compression, cooling, expansion, heating) producing a cooling power at least one end that can be transferred by heat exchange. For example, the refrigerator is a reverse Brayton cycle refrigerator, and more specifically a turbo-Brayton refrigerator, using turbomachines (coupling on a single shaft at least one compressor and one turbine on bearings and magnetic motor). The subcooling circuit 4, 5 comprises at least one injection end 5, 7 configured to inject the fluid cooled in the heat exchanger 6 into the store 2.

In the example illustrated, the subcooling circuit 4, 5 comprises two injection ends 5, 7. A first end opens into the upper part of the store in the form of a nozzle or nozzles to enable the cooled fluid to be injected into the gas phase of the store 2 in order to recondense the vapours and control the pressure in the store 2.

A second end for example opens into the lower part of the store 2 to cool the liquid phase.

According to the invention, the ejector at the bottom of the store 2 (injector) preferably returns the liquefied gas and mixes it in the liquid phase. The injected liquid is no longer subcooled, but at the same temperature as the liquid in the store 2.

The device 1 further comprises a boil-off gas recovery pipe 8 with an upstream end connected to an upper portion of the store 2 and configured to recover boil-off gas. The recovery pipe 8 preferably comprises at least one compression unit 11 for the recovered boil-off gas (typically at least one compressor). The recovery pipe 8 comprises downstream at least one downstream end 18 intended to be connected to a consumer of the boil-off gas, for example a burner and/or a motor. This compression 11 makes it possible to keep a constant pressure in the store 2 and to supply gas to the motors. The excess combustible boil-off gas can be conveyed to a combustion flare, for example.

The device 1 comprises a bypass pipe 9 and a set of valves 10 configured to enable the boil-off gas to be transferred from the recovery pipe 8 to the subcooling circuit 4, 5. This bypass pipe 9 has a first end connected to the recovery pipe 8, preferably downstream of the compression unit 11, and a second downstream end connected to the subcooling circuit 4, 5 upstream of the heat exchanger 6. For example, the set of valves comprises a flow control valve 10 on the bypass pipe 9.

This makes it possible to obviate clogging by injecting of drawn boil-off gas, for example following compression, for example at ambient temperature.

This makes it possible to inject relatively hotter gas upstream of the cooling by the refrigerator/liquefactor. This gas brought by the bypass pipe 9 may be mixed inside a cryogenic liquid flow drawn from the store via the aspiration pipe 4 of the subcooling circuit.

The drawn gas mixed with the liquid flow is preferably at a pressure at least greater than the delivery pressure of the liquid aspiration pump 17 located at the bottom of the cryogenic fluid store 2.

As illustrated, the device 1 may include a mixing unit 12 for the boil-off gas in the subcooling circuit 4, 5. This mixing unit 12 is configured to partially or totally mix the gas in the liquid and is located for example at the junction between the downstream end of the bypass pipe 9 and the subcooling circuit 4, 5. This mixing unit 12 for example comprises at least one of the following: an indirect heat exchanger with injection, a gas injector into the liquid, a static mixer, an upstream injector, a filtration system, a condensate pot with random or structured packing, or any other suitable unit or combination of several of these technologies.

The flow control valve 10 is for example a controlled valve that may be configured to transfer a boil-off gas flow to the subcooling circuit 4, 5 to increase the temperature of the fluid entering the heat exchanger 6 by a given value, for example between 5° C. and 25° C.

For example, the flow control valve 10 may be configured to transfer a boil-off gas flow to the subcooling circuit 4, 5 to keep the temperature of the fluid entering the heat exchanger 6 below the saturation temperature of the liquefied gas. This enables the mixture to remain in liquid phase. A temperature margin, for example 2° C. below saturation, may be provided to guarantee that no gas bubbles enter the heat exchanger 6.

The gas flow mixed upstream of the heat exchanger 6 may be controlled for example by calculating a saturation temperature of the fluid (the bubble point temperature being the temperature at which the first vapour bubble is created).

This saturation temperature may be based on a typical composition of the stored fluid.

This saturation temperature may be adjusted according to a correlation via a pressure parameter for example. This makes it possible to control the injection of boil-off gas by the flow control valve 10 until the output temperature from the mixer 10 is a temperature with a safety margin in relation to the saturation temperature (output temperature from the mixer 12 being equal to the saturation temperature of the fluid less than the safety margin).

Alternatively or in combination, the flow control valve 10 may be controlled to keep the temperature of the fluid coming out of the heat exchanger 6 above a given value, for example above −160° C., and/or at a value equal to the temperature of the liquefied gas in the store, and/or at a value equal to the temperature of the liquefied gas aspirated at the aspiration end 4.

For example, the temperature of the fluid may be measured at the output of the pump 17 and/or in the store 2. The flow rate may be adjusted by the flow control valve 10 to ensure that the temperature of the fluid at the output of the cooling heat exchanger 6 is equal to the temperature of the liquid in the store 2.

The pressure increase in the pumped liquid enables the saturation point thereof to be raised. This enables total or partial solubility of the gas in the cryogenic liquid upstream of the liquefactor.

This dissolution of the boil-off gas in the liquid is caused by an increase in the temperature of the cryogenic liquid.

The quantity of gas injected via the bypass pipe 9 makes it possible to choose to control a temperature at the input and/or the output of the refrigerator (at the input and/or output of the heat exchanger 6. This control can be effected by a single flow control valve 10. The temperature of the fluid to be cooled can therefore be measured at the input and/or output of the heat exchanger 6 by one or more appropriate temperature sensors 19.

The refrigerator 3 reduces the temperature of the liquid or of the gas/liquid mixture obtained before returning it to the store 2 (at the bottom of the store and/or in the upper part via one or more booms or nozzles).

The temperature of the fluid at the output of the cooling heat exchanger 6 is thus controlled so as to create no or less solidification inside the heat exchanger 6. This temperature is therefore at least equal to the initial temperature of the cryogenic liquid pumped from the store 2. The quantity of gas injected via the bypass pipe 9 can also make it possible to regulate the pressure drop inside the heat exchanger 6.

The device 1 can also be used in “mixed” mode, i.e. combining, on one hand, liquefaction of the boil-off gas recovered, compressed and reinjected, and, on the other hand, a partial subcooling of the cryogenic liquid before returning to the store 2.

The device 1 can alternatively operate in subcooling mode, in which the injection of the relatively hotter boil-off gas via the bypass pipe 9 is stopped (valve 10 closed) or in liquefaction mode by injecting boil-off gas via the bypass pipe 9 (valve 10 open).

This provides a flexible system offering two operating modes. Switching from one mode to the other can be decided for example arbitrarily by an operator depending on the risk of blockage of the heat exchanger 6 and/or automatically via detection or prediction (intelligence) by detecting a blockage (increasing pressure difference at the terminals of the heat exchanger 6, temperature drop, etc.).

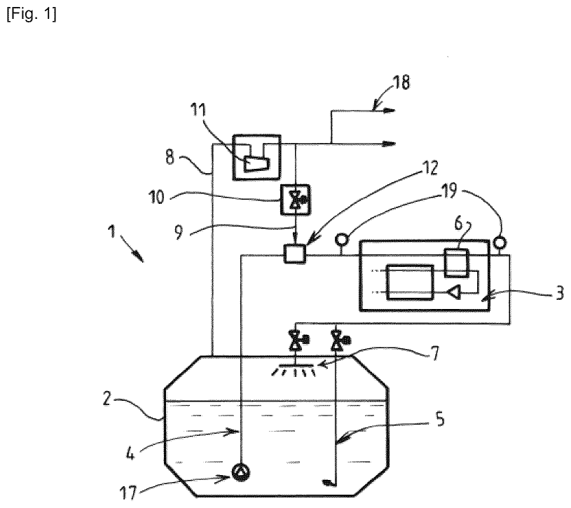

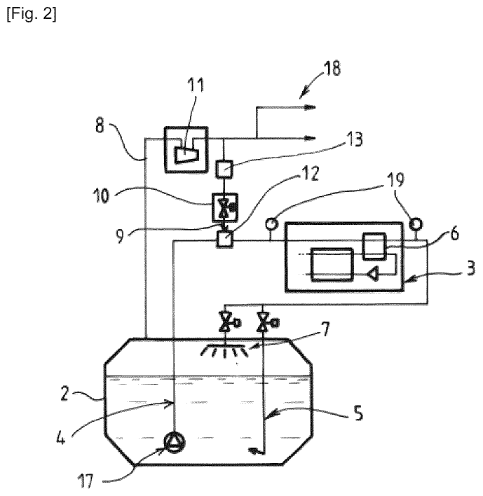

The embodiment in [FIG. 2] differs from the embodiment in [FIG. 1] in that the bypass pipe 9 comprises a pre-cooling unit 13 in thermal exchange with the boil-off gas being transferred to the subcooling circuit 4, 5. This pre-cooling unit 13 can for example be configured to cool the transferred boil-off gas flow to an intermediate temperature between the temperature of the boil-off gas in the recovery pipe 8 and the temperature of the liquefied gas being pumped from the store 2.

This makes it possible to optimize or increase the quantity of compressed gas that can be injected via the external pre-cooling unit 13 at an intermediate temperature between the temperature of the cryogenic liquid and ambient temperature. For example, this pre-cooling unit 13 may comprise or be made up of at least one of the following: a refrigeration cycle using a refrigerant fluid, a compression system, and a valve-, orifice- or turbine-based expansion system.

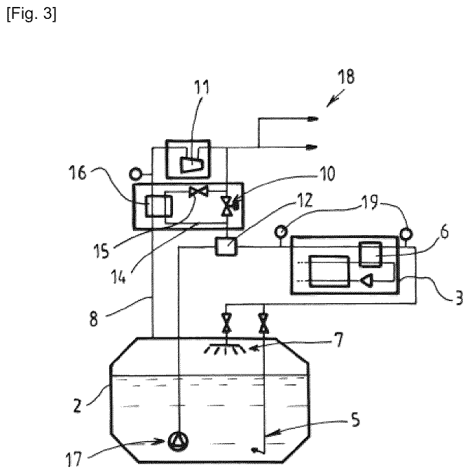

The embodiment in [FIG. 3] differs from the embodiment in [FIG. 1] in that the recovery pipe 8 comprises a heat exchanger 16 enabling a heat exchange between the boil-off gas in the recovery pipe 8 and the boil-off gas in the bypass pipe 9. For example, the bypass pipe 9 comprises a detour pipe 14 and a set of valves 15 to control the flow of boil-off gas in the bypass pipe 9 admitted to flow through the heat exchanger 16 on the recovery pipe 8.

This enables the boil-off gas to be pre-cooled by recovering cooling power from the boil-off gas drawn from the store 2 upstream of compression.

One or more control valves can be used to selectively control the temperature of the gas at the input of the compression unit, the temperature of the fluid at the input of the refrigerator (entering the heat exchanger 6), or the temperature of the fluid at the output of the heat exchanger 6. This control can be used to maximize the cooling power recovered while guaranteeing proper operation of the compression 11 and preventing the formation of solids in the heat exchanger 6 of the refrigerator 3. This makes it possible to optimize/increase the quantity of compressed boil-off gas that can be injected via the bypass pipe 9.

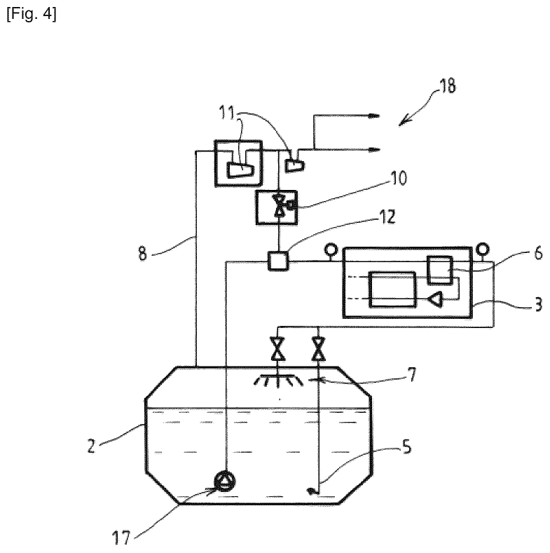

The embodiment in [FIG. 4] differs from the embodiment in [FIG. 1] in that the recovery pipe 8 comprises several compressors 11 in series and the first upstream end of the bypass pipe 9 is connected to the recovery pipe 8 downstream of an intermediate compressor 11, i.e. upstream of the last compressor in the series.

This means that the boil-off gas is recovered at the output of the first or a subsequent compression stage rather than at the output of the last compressor. The pressure of the recovered gas is however preferably greater than the pressure of the liquid pumped from the store with which it is mixed. The temperature of this boil-off gas at an intermediate compression stage is relatively colder than at the output of the last compressor. The quantity of boil-off gas that can be mixed with the liquid may then be greater than in the embodiment in [FIG. 1]. This embodiment can also replace the pre-cooling unit 13 of the embodiment in [FIG. 2].

The device therefore enables optimum management of the boil-off gases and cold maintenance (notably subcooling) of a liquefied gas store, for example for methane, without generating solid deposits in the cooling heat exchanger 6. The invention makes it possible to obviate or limit degradation of performance in the device.

The boil-off gas injected upstream of the heat exchanger 6 of the refrigerator 3 heats the liquid before it is cooled. The refrigerator 3 then brings this mixture for example to the temperature of the fluid in the store 2.

The drawn and mixed boil-off gas 9 is totally or partially liquefied when returned to the store 2. The coldest temperature reached by the fluid in the heat exchanger 6 does not enable solidification conditions to be reached.

The solution described enables conversion by adaptation of a conventional subcooling system into a direct re-liquefactor in the presence of heavy hydrocarbon contaminants. The solution prevents crystallization of heavy hydrocarbons during cooling.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1. A device for keeping a liquefied gas store cold, comprising:
a cryogenic refrigerator,
a subcooling circuit comprising a set of pipes, the subcooling circuit comprising an aspiration end configured to be seated in a lower portion of a liquefied gas store and configured to aspirate the liquefied gas,
a heat exchanger exchanging heat between the fluid aspirated by subcooling circuit and the refrigerator, the subcooling circuit comprising at least one injection end configured to inject the fluid cooled in the heat exchanger into the store,
a boil-off gas recovery pipe having an upstream end configured to be connected to an upper portion of the store to recover the boil-off gas, the recovery pipe comprising a downstream end configured to be connected to a consumer of boil-off gas, and
a bypass pipe and a set of valves configured to enable boil-off gas to be transferred from the recovery pipe to the subcooling circuit, the bypass pipe having a first end connected to the recovery pipe and a second end connected to the subcooling circuit,
wherein the second end of the bypass pipe is connected to the subcooling circuit upstream of the heat exchanger.

2. The device of claim 1, wherein the set of valves comprises a flow control valve on the bypass pipe.

3. The device of claim 2, wherein the flow control valve is a controlled valve configured to transfer a boil-off gas flow to the subcooling circuit to increase the temperature of the fluid entering the heat exchanger by a given value.

4. The device of claim 2, wherein the flow control valve is a controlled valve configured to transfer a boil-off gas flow to the subcooling circuit to keep the temperature of the fluid entering the heat exchanger below the saturation temperature of the liquefied gas.

5. The device of claim 2, wherein the flow control valve is a controlled valve configured to transfer a boil-off gas flow to the subcooling circuit to keep the temperature of the fluid coming out of the heat exchanger above a given value, and/or at a value equal to the temperature of the liquefied gas in the store, and/or at a value equal to the temperature of the liquefied gas aspirated at the aspiration end.

6. The device of claim 1, wherein the recovery pipe comprises at least one compressor and in that the first end of the bypass pipe is connected to the recovery pipe downstream of the compressor.

7. The device of claim 6, wherein the recovery pipe comprises several compressors in series and in that the first end of the bypass pipe is connected to the recovery pipe downstream of an intermediate compressor.

8. The device of claim 6, wherein the compressor is configured to supply a gas flow to the bypass pipe at a pressure greater than the pressure of the liquid aspirated at the aspiration end and delivered to the subcooling circuit.

9. The device of claim 1, further comprising a mixing unit for mixing the boil-off gas into the subcooling circuit, the mixing unit being located at the junction between the second end of the bypass pipe and the subcooling circuit, the mixing unit comprising at least one of the following: an indirect heat exchanger with injection, a gas injector into the liquid, a static mixer, an upstream injector, a filtration system, a condensate pot with random or structured packing.

10. The device of claim 1, wherein the bypass pipe comprises a pre-cooling unit in thermal exchange with the boil-off gas being transferred to the subcooling circuit, the pre-cooling unit being configured to cool the transferred boil-off gas flow to an intermediate temperature between the temperature of the boil-off gas in the recovery pipe and the temperature of the liquefied gas.

11. The device of claim 1, wherein the recovery pipe comprises a heat exchanger enabling a heat exchange between the boil-off gas in the recovery pipe and the boil-off gas in the bypass pipe.

12. The device of claim 11, wherein the bypass pipe comprises a detour pipe and a set of valves to control the flow of boil-off gas in the bypass pipe admitted to flow through the heat exchanger on the recovery pipe.

13. The device of claim 1, wherein the aspiration end comprises an aspiration pump.

14. A liquefied gas storage facility comprising at least one liquefied gas store and a device for keeping the fluid contained in the store cold, the cold maintenance device being as claimed in claim 1.

15. A method for keeping a liquefied gas store cold using the device of claim 1, comprising pumping liquefied gas from a cryogenic store, cooling the pumped liquefied gas and re-injecting the cooled liquefied gas into the store, the method comprising recovering boil-off gas from the store, and a step of injecting and mixing boil-off gas into the pumped liquefied gas before it is cooled.

16. The method of claim 15, wherein the injecting and mixing step is configured to raise the temperature of the pumped liquefied gas before cooling by a given value, and/or to keep the temperature of the cooled liquefied gas below a given threshold and/or at the temperature of the stored or pumped liquefied gas.
